(19) United States
(12) Patent Application Publication
(10) Pub. No.: US 2008/0211186 A1
(43) Pub. Date: Sep. 4, 2008

(54) PLAYING METHOD OF CARD GAME AND GAMING DEVICE

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/039,470

(22) Filed: Feb. 28, 2008

(30) Foreign Application Priority Data
Mar. 1, 2007 (JP) 2007-051713

(51) Int. Cl. A63F 13/00; A63F 1/00

(52) U.S. Cl. 273/292; 463/12

(57) ABSTRACT

A playing method of a card game includes a main game and a sub game that are performed when making a bet. The method includes the steps of: (a) making a first bet on the main game; (b) making a second bet on the sub game; (c) performing the main game after the first and second bets are made, and displaying a plurality of playing cards showing a result of the main game; (d) performing a payout for the first bet in accordance with a rule of the main game, based on the result of the main game; (e) counting how many the playing cards showing the result of the main game correspond to a predetermined rank; and (f) performing a payout for the second bet in accordance with a rule of the sub game when there are a predetermined number of playing cards corresponding to the predetermined rank.

### CROSS REFERENCE TO RELATED APPLICATION

This application is based upon and claims the benefit of priority from the prior Japanese Patent Application No. 2007-051713, filed on Mar. 1, 2007, the entire contents of which are incorporated herein by reference.

### BACKGROUND OF THE INVENTION

1. Field of the Invention

The invention relates to a playing method of a card game that is performed when making a bet, and a gaming device.

2. Description of Related Art

A baccarat game is known, which is one of card games that are performed when making a bet. In a baccarat game, a game participant expects which one of two fictitious players, i.e., “BANKER” and “PLAYER” will win or tie and then makes a bet every one game. In other words, the bet is made only on one event during one game. Due to this, the game participant is less satisfied with the game, compared to the consuming time of the game. This problem also occurs in the other card games such as black jack, in addition to the baccarat game.

### SUMMARY OF THE INVENTION

An object of the invention is to provide a playing method of a card game and a gaming device, capable of increasing a sense of satisfaction of a game participant or a user of the gaming device in a game.

According to a first aspect of the invention, there is provided a playing method of a card game including a main game and a sub game that are performed when making a bet, the method comprising the steps of: (a) making a first bet on the main game; (b) making a second bet on the sub game; (c) performing the main game after the first and second bets are made, and displaying a plurality of playing cards showing a result of the main game; (d) performing a payout for the first bet in accordance with a rule of the main game, based on the result of the main game; (e) counting how many the playing cards showing the result of the main game correspond to a predetermined rank; and (f) performing a payout for the second bet in accordance with a rule of the sub game when there are a predetermined number of playing cards corresponding to the predetermined rank.

According to a second aspect of the invention, there is provided a playing method of a card game including a main game and a sub game that are performed when making a bet, the method comprising the steps of: (a) making a first bet on the main game; (b) making a second bet on the sub game; (c) performing the main game after the first and second bets are made, and displaying a plurality of playing cards showing a result of the main game; (d) performing a payout for the first bet in accordance with a rule of the main game, based on the result of the main game; (g) determining whether there are the playing cards, which show the result of the main game, corresponding to a deck of predetermined different ranks; and (h) performing a payout for the second bet in accordance with a rule of the sub game when there are the playing cards corresponding to the deck of predetermined ranks.

According to a third aspect of the invention, there is provided a playing method of a card game including a main game and a sub game that are performed when making a bet, the method comprising the steps of: (a) making a first bet on the main game; (b) making a second bet on the sub game; (c) performing the main game after the first and second bets are made, and displaying a plurality of playing cards showing a result of the main game; (d) performing a payout for the first bet in accordance with a rule of the main game, based on the result of the main game; (i) determining whether there are the playing cards, which show the result of the main game, corresponding to a deck of predetermined different ranks and the playing cards constitute a predetermined suit; and (j) performing a payout for the second bet in accordance with a rule of the sub game when there are the playing cards corresponding to the deck of predetermined ranks and the playing cards constitute a predetermined suit.

According to a fourth aspect of the invention, there is provided a gaming device comprising: a terminal that is operated by a user when making a bet based on a card game including a main game and a sub game; a memory that stores a rule of the main game and a rule of the sub game; and a controller that operates: (a) to receive first bet information about the main game from the terminal; (b) to receive second bet information about the sub game from the terminal; (c) to perform the main game after receiving the first and second bet information, and to display a plurality of playing cards showing a result of the main game; (d) to perform a payout for the first bet in accordance with the rule of the main game, based on the result of the main game; (e) to count how many the playing cards showing the result of the main game correspond to a predetermined rank; and (f) to perform a payout for the second bet in accordance with the rule of the sub game when there are a predetermined number of cards corresponding to the predetermined rank.

According to a fifth aspect of the invention, there is provided a gaming device comprising: a terminal that is operated by a user when making a bet based on a card game including a main game and a sub game; a memory that stores a rule of the main game and a rule of the sub game; and a controller that operates: (a) to receive first bet information about the main game from the terminal; (b) to receive second bet information about the sub game from the terminal; (c) to perform the main game after receiving the first and second bet information, and to display a plurality of playing cards showing a result of the main game; (d) to perform a payout for the first bet in accordance with the rule of the main game, based on the result of the main game; (g) determining whether there are the playing cards, which show the result of the main game, corresponding to a deck of predetermined different ranks; and (h) performing a payout for the second bet in accordance with a rule of the sub game when there are the playing cards corresponding to the deck of predetermined ranks.

According to a sixth aspect of the invention, there is provided a gaming device comprising: a terminal that is operated by a user when making a bet based on a card game including a main game and a sub game; a memory that stores a rule of the main game and a rule of the sub game; and a controller that operates: (a) to receive first bet information about the main game from the terminal; (b) to receive second bet information about the sub game from the terminal; (c) to perform the main game after receiving the first and second bet information, and to display a plurality of playing cards showing a result of the main game; (d) to perform a payout for the first bet in accordance with the rule of the main game, based on the result of the main game; (i) determining whether there are the playing cards, which show the result of the main game, corresponding to a deck of predetermined different ranks and the playing cards constitute a predetermined suit; and (j) performing a payout for the second bet in accordance with a rule of the sub game when there are the playing cards corresponding to the deck of predetermined ranks and the playing cards constitute a predetermined suit.

In the first to sixth aspects, a game participant or a user of a gaming device makes a bet on two events of a main game and a sub game during one game. Thereby, it is possible to increase a sense of satisfaction of the game participant or the user of the gaming device in a game.

### BRIEF DESCRIPTION OF THE DRAWINGS

Other and further objects, features and advantages of the invention will appear more fully from the following description taken in connection with the accompanying drawings, in which:

FIG. 1 is a plan view showing an example of a game system that is used for an embodiment of a playing method of the invention;

FIG. 2 is a flow chart showing the embodiment of a playing method of the invention;

FIG. 3 is a table showing points of playing cards in a main game;

FIGS. 4 and 5 are tables that respectively show actions of “PLAYER” and “BANKER” in accordance with scores of two playing cards, which are initially distributed, in the main game;

FIG. 6 is a table showing payout contents of bets on the main game;

FIG. 7 is a table showing payout contents of bets on a sub game;

FIG. 8 is a table showing payout contents of bets on a sub game, which is applied in a first modified example of the embodiment of a playing method of the invention;

FIG. 9 is a table showing payout contents of bets on a sub game, which is applied in a second modified example of the embodiment of a playing method of the invention;

FIG. 10 is a plan view showing an example of a game system that is used to execute the second modified example of a playing method of the invention;

FIG. 11 is an external perspective view showing an embodiment of a gaming device of the invention;

FIG. 12 is a perspective view showing a terminal included in the gaming device;

FIG. 13 shows a BET screen that is displayed on a display provided to the terminal;

FIG. 14 shows an example of an image illustrating contents of a main game that is displayed on a common display included in the gaming device;

FIG. 15 is a block diagram showing an electrical structure of a controller included in the gaming device;

FIG. 16 is a block diagram showing an electrical structure of a server included in the gaming device;

FIG. 17 shows a memory area of a ROM of a server;

FIG. 18 shows a memory area of a RAM of the server;

FIG. 19 is a block diagram showing an electrical structure of a terminal;

FIGS. 20 and 21 are flow charts showing game processes that are performed by the server and a controller;

FIG. 22 is a flow chart showing a game process that is performed by a terminal;

FIG. 23 is a flow chart showing a bet time confirming process that is shown in FIG. 22;

FIG. 24 is a flow chart showing a bet receiving process that is shown in FIG. 22; and

FIG. 25 shows a BET screen in a modified example of the embodiment of a gaming device of the invention;

### DESCRIPTION OF THE PREFERRED EMBODIMENTS

Hereinafter, it will be described an embodiment of a gaming device according to the invention with reference to the drawings.

In following embodiments and examples, a baccarat game is applied as a card game. In the baccarat game, various modified games are provided in which a modification is added to a main game such as Banque a Tout Va, Chemin De Fer, Punto Banco, mini baccarat and the like. Rules of the respective modified games are different. In addition, the rules of the modified games may be different depending on the game arcades such as casino and the like. However, the rules of a main game on which the modified games are based are same in any modified games.

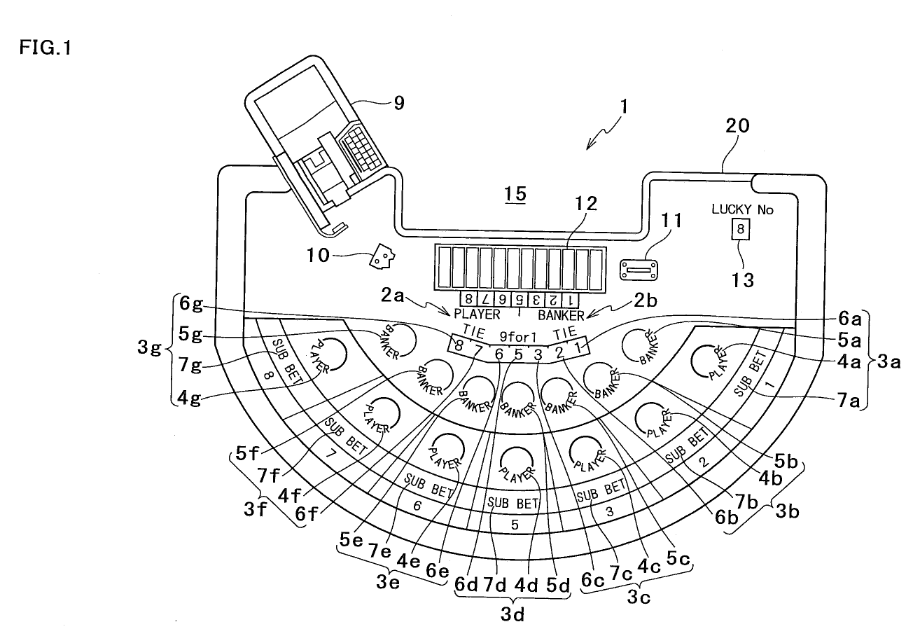

First, an embodiment of a playing method of the invention will be described with reference to FIGS. 1 to 7.

In this embodiment, a baccarat game includes a sub game in addition to a main game. In a main game, a game participant expects which one of two fictitious players, i.e., “BANKER” and “PLAYER” will win or tie and then makes a bet with a chip that is used as a game medium. A participant of the main game can arbitrarily take part in a sub game and a result thereof depends on a result of the main game, which will be specifically described later.

FIG. 1 shows an example of a game system that is used to execute the embodiment of a playing method of the invention. As shown in FIG. 1, a game system 1 includes a large semi-circular table 20. Around a dealer who serves as a game master, seven spaces in which game participants are respectively located are provided about the table 20, in a radial form. In other words, maximum 7 gamers can participate in a game in the game system 1.

On an upper surface of the table 20, a player card area 2a and a banker card area 2b, on which the playing cards distributed by the dealer are put, are provided to a front of a dealer area 15. A playing card of “PLAYER” and a playing card of “BANKER” are respectively put on the player card area 2a and the banker card area 2b.

Around the table 20, bet areas 3a, 3b, 3c, 3d, 3e, 3f, 3g are provided so that the game participants make a bet. The numbers of 1, 2, 3, 4, 5, 6 and 7 are allotted to each of the bet areas 3a to 3g.

The bet areas 3a to 3g have player bet areas 4a to 4g, banker bet areas 5a to 5g, tie bet areas 6a to 6g and sub bet areas 7a to 7g. The player bet areas 4a to 4g, the banker bet areas 5a to 5g and the tie bet areas 6a to 6g are areas for making a first bet on a main game and the sub bet areas 7a to 7g are area for making a second bet on a sub game.

A participant who expects a win of “PLAYER” puts a chip on the player bet areas 4a to 4g. A participant who expects a win of “BANKER” puts a chip on the banker bet areas 5a to 5g. A participant who expects a tie puts a chip on the tie bet areas 6a to 6g. One participant is prevented from putting the chips on both the player bet areas 4a to 4g and the banker bet areas 5a to 5g. One participant is permitted to put the chips on both the player bet areas 4a to 4g or banker bet areas 5a to 5g and the tie bet areas 6a to 6g.

A participant who wants to take part in a sub game puts on a chip on the sub bet areas 7a to 7g. However, a participant who does not make a bet on a main game, i.e., who does not put a chip on any of the player bet areas 4a to 4g, the banker bet areas 5a to 5g and the tie bet areas 6a to 6g cannot take part in a sub game. In other words, a bet on a main game is indispensable.

Moreover, the game system 1 has a shuffle device 9 that shuffles one or more decks of playing cards, a discard area 10, a bill insertion slot 11, a chip tray 12 and a lucky number indicator 13.

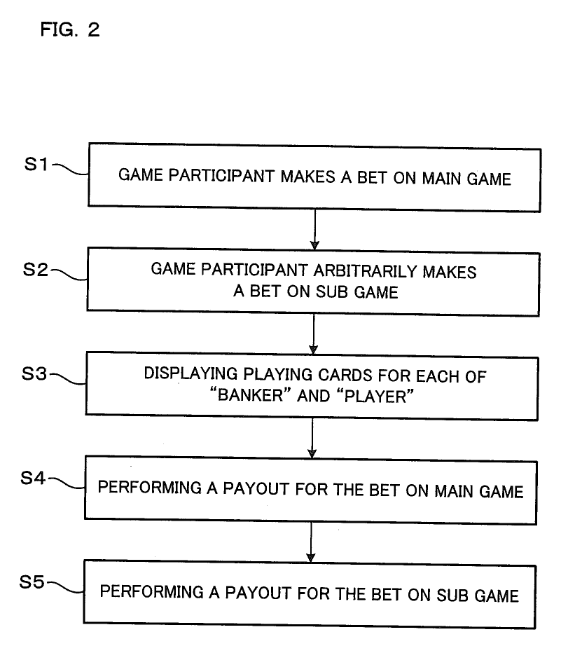

In the followings, a playing method of this embodiment will be described with reference to FIG. 2.

First, a participant makes a bet on a main game (S1). At this time, the participant puts the chips on the player bet areas 4a to 4g when expecting a win of “PLAYER”, on the banker bet areas 5a to 5g when expecting a win of “BANKER” and on the tie bet areas 6a to 6g when expecting a tie, respectively.

After that, the participant arbitrarily makes a bet on a sub game (S2). At this time, the participant puts the chips on the sub bet areas 7a to 7g of the areas 7a to 7g of the participant.

The bets on the main game and the sub game are made for a predetermined time period. In other words, when a predetermined time period has elapsed, the participant is prevented from making a bet.

After the step of S2, the playing cards are distributed to each of “BANKER” and “PLAYER.” In other words, the playing cards are put on the player card area 2a and the banker card area 2b, which are displayed to the participant (S3). At this time, the playing cards are discharged one by one from the shuffle device 9 and a dealer distributes the two playing cards to each of “BANKER” and “PLAYER”, respectively, with the playing cards being turned upside down. Then, the dealer turns up the four playing cards in the player card area 2a and the banker card area 2b, so that the ranks of the cards are displayed to the participant. Then, the dealer deals out a third card to “PLAYER”, in accordance with the score based on the two cards of “PLAYER.” Likewise, the dealer deals out a third card to “BANKER”, in accordance with the score based on the two cards of “BANKER.” The third cards are distributed with being turned up.

Here, an outline of rules of a main game will be described.

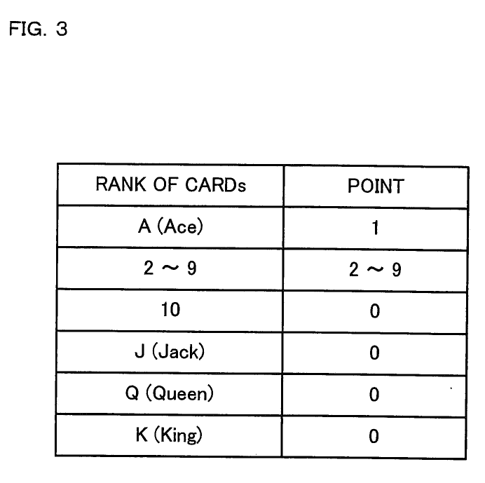

As shown in FIG. 3, points are set in accordance with the ranks of the respective playing cards, i.e., the numbers of symbols of A, 2 to 10, J, Q and K depicted on the playing cards. To be more specific, the playing card of “A (ace)” is valued at “1”, the playing cards of “2” to “9” are valued at “2” to “9” and the playing cards of “10”, “J (Jack)”, “Q (Queen)” and “K (King)” are valued at “0 (zero)”. The points corresponding to the playing cards distributed are summed up and the value of a first place of the summed value is a “score.”

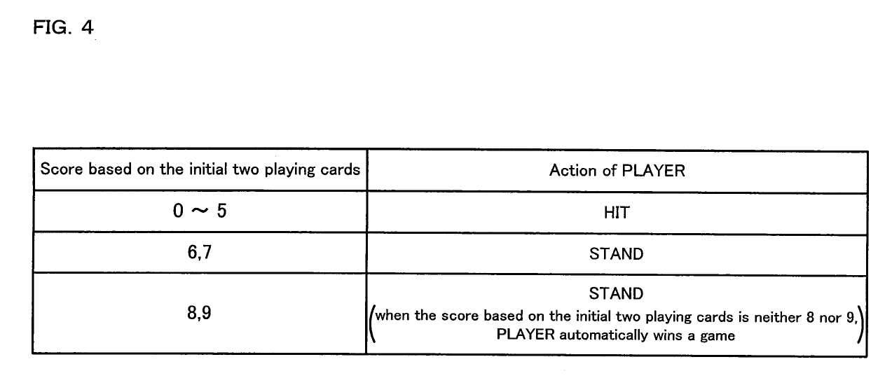

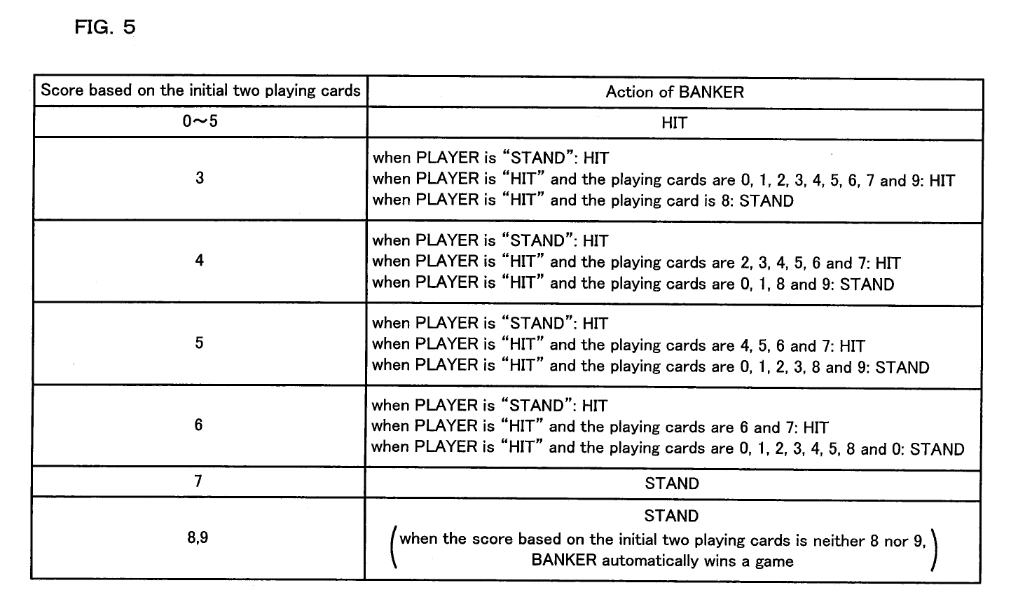

For each of “BANKER” and “PLAYER”, the scores are calculated on the basis of the two playing cards that are initially distributed. In accordance with the score, an action shown in FIG. 4 is performed for “PLAYER” and an action shown in FIG. 5 is performed for “BANKER.” For example, as shown in FIG. 4, when the score based on the two playing cards, which are initially distributed to “PLAYER”, is a value (0 to 5) corresponding to “HIT”, a third card is distributed to “PLAYER” and when the score is a value (6, 7) corresponding to “STAND”, a third card is not distributed to “PLAYER.”

In the mean time, in the step of S3, when distributing the playing cards to “BANKER” and “PLAYER,” the playing cards may be distributed with being turned upside down, i.e., with the ranks depicted on the surfaces of the playing cards being invisible to the participant, or with being turned up, i.e., with the ranks being visible to the participant. However, before the step of S4, all the playing cards are necessarily turned up.

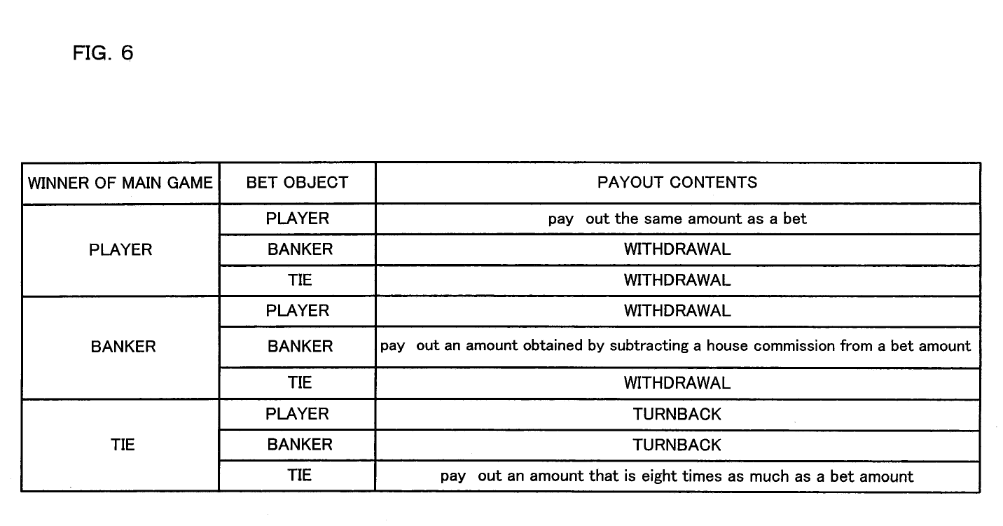

After the step of S3, based on a result of the main game, a payout for the first bet is performed in accordance with the rules of the main game (S4). At this time, for each of “BANKER” and “PLAYER,” the scores are calculated on the basis of the two or three playing cards that are distributed in the step of S3. Based on the scores, a win or defeat in this game is determined. To be more specific, the party having the score that is closer to “9” becomes a winner. When the scores are same, a tie is made. Depending on the result of the win or defeat, the contents of payout for the main game are determined on the basis of the table shown in FIG. 6.

Specifically, when a winner of the main game is “PLAYER,” the chips having the amount same as the bet amount are paid out to the participant who has made a bet on “PLAYER” and the chips of the participant who has made a bet on “BANKER” and “TIE” are withdrawn. When a winner of the main game is “BANKER,” the chips having an amount that a house commission of a game arcade, for example 5% of the bet amount is subtracted from the bet amount are paid out to the participant who has made a bet on “BANKER” and the chips of the participant who has made a bet on “PLAYER” and “TIE” are withdrawn. When a result of the game is “TIE,” the chips, which are eight times as much as the bet amount, are paid out to the participant who has made a bet on “TIE” and the chips of the participant who has made a bet on “PLAYER” and “BANKER” are turned back. Meanwhile, the payout contents of a bet on the main game may be determined for each of the game arcades.

When paying out the chips, the dealer draws out the chips from the chip tray 12 and then gives them to the corresponding participant. When withdrawing the chips, the dealer withdraws the chips, which are put on the bet areas 3a to 3g of the corresponding participant, and then puts them into the chip tray 12.

After the step of S4, a payout for the second bet is performed in accordance with the rules of the sub game (S5). At this time, regarding the playing cards showing a result of the main game, i.e., all the playing cards put on the player card area 2a and the banker card area 2b, it is counted how many the playing cards corresponding to the predetermined rank, i.e., lucky number are. When there are a predetermined number of playing cards corresponding to the lucky number, the payout about the bet on the sub game is performed.

The lucky number is one of the numbers or symbols of A, 2 to 10, J, Q and K, is determined by the dealer before receiving a bet, i.e., before the step of S1 and is displayed on the lucky number indicator 13 (see FIG. 1). In the example of FIG. 1, the lucky number is “8.”

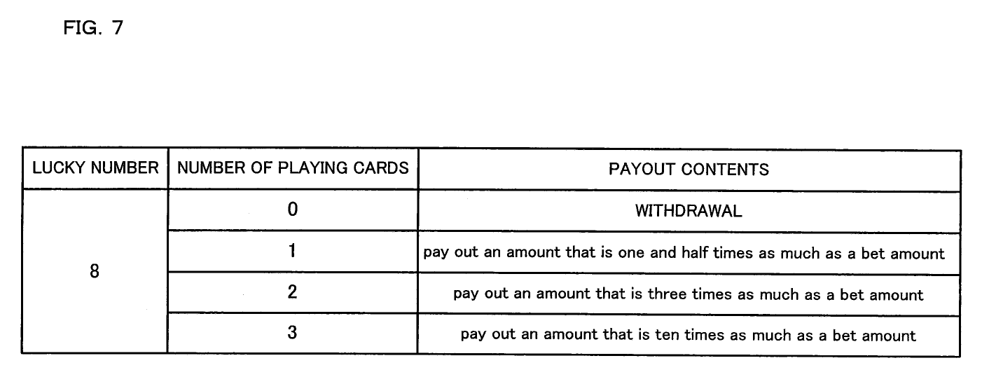

The payout of S5 will be specifically described with reference to a table of FIG. 7. In an example of FIG. 7, the lucky number is “8.” Regarding the playing cards put on the player card area 2a and the banker card area 2b, when the number of the playing cards corresponding to the lucky number, i.e., the playing cards of “8” is 0, the chips are withdrawn. When the number is 1, the chips of an amount that is one and half times as much as the bet amount are paid out. When the number is 2, the chips of an amount that is three times as much as the bet amount are paid out. When the number is 3, the chips of an amount that is ten times as much as the bet amount are paid out. Like this, in this embodiment, the more the number of playing cards corresponding to the lucky number, the higher the payout rate.

As described above, according to this embodiment, a game participant can make a bet on both events of a main game and a sub game during one baccarat game. Thereby, it is possible to increase the sense of satisfaction of the game participant in a game.

In addition, as shown in FIG. 7, in a sub game, the more the number of playing cards corresponding to the lucky number, the higher the payout rate. Thereby, the expectation to a payout is gradually increased with the display of the playing cards.

Meanwhile, in a sub game, the predetermined rank for a sub game, i.e., the lucky number may be any one, in addition to “8.”

The steps of S1 and S2 may be inversely carried out with regard to the execution order thereof, or alternatively, may be performed at the same time. The steps of S4 and S5 may be inversely carried out with regard to the execution order thereof, or alternatively, may be performed at the same time.

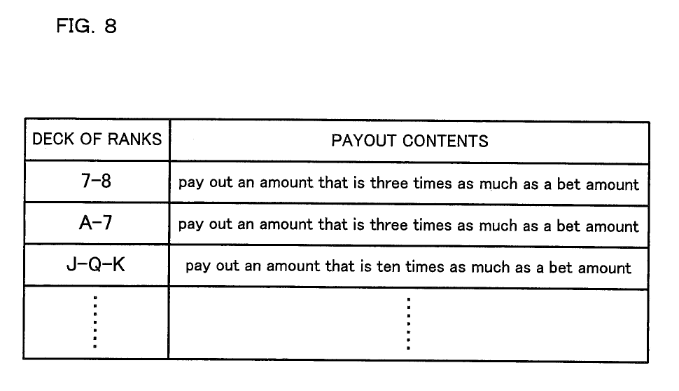

In the followings, a first modified example of the embodiment of the playing method of the invention will be described with reference to FIG. 8.

This modified example is different from the above embodiment, in view of the rules of the sub game only. In a sub game of this modified example, regarding the playing cards showing a result of the main game, i.e., all the playing cards put on the player card area 2a and the banker card area 2b, it is determined whether there is one corresponding to a deck of predetermined different ranks. When there is one corresponding to a deck of predetermined ranks, the payout for a bet on a sub game is performed (S5).

The deck of predetermined ranks is a deck of different two or more ranks of “7”, “8”, “J”, “Q”, “K” and the like, is determined by a dealer before receiving a bet, i.e., before the step of S1 and is displayed on the lucky number indicator 13 (see FIG. 1). The deck of predetermined ranks may be a poker combination such as one pair, two pairs, full house and the like.

In the payout process of S5, a table shown in FIG. 8 is referred to. To be more specific, regarding the playing cards put on the player card area 2a and the banker card area 2b, when the deck of predetermined ranks is “7” and “8” or “A” and “7” and there are the cards corresponding to the rank deck, the chips of an amount that is three times as much as the bet amount are paid out. When the deck of predetermined ranks is “J, “Q” and “K” and there are the cards corresponding to the rank deck, the chips of an amount that is ten times as much as the bet amount are paid out. Like this, in this modified example, when the deck has the more different ranks, the payout rate is higher. For instance, in the example of FIG. 8, the deck having the three ranks of “J”, “Q” and “K” has the higher payout rate than the deck having the two ranks of “7” and “8” or “A” and “7.”

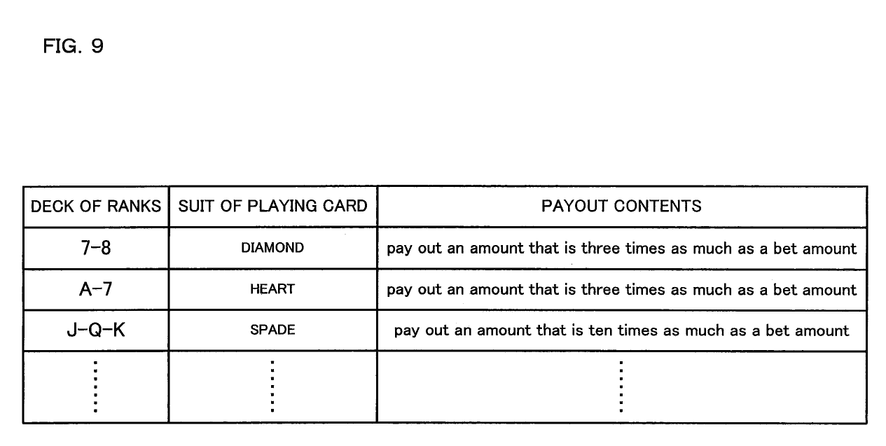

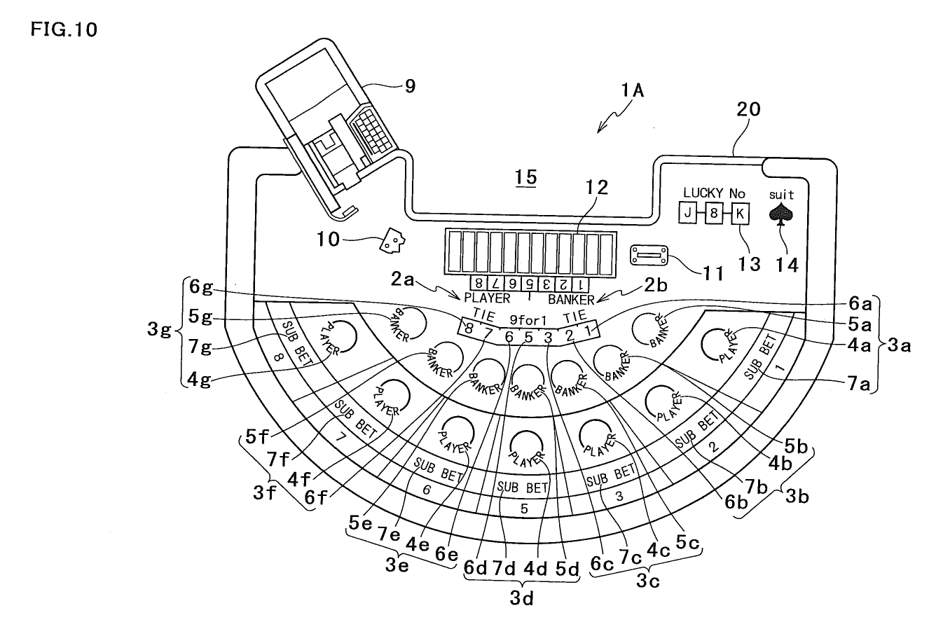

In the followings, a second modified example of the embodiment of the playing method of the invention will be described with reference to FIGS. 9 and 10.

This modified example is same as the above embodiment, except the rules of the sub game. In a sub game of this modified example, regarding the playing cards showing a result of the main game, i.e., all the playing cards put on the player card area 2a and the banker card area 2b, it is determined whether there are playing cards corresponding to the deck of the predetermined different ranks and the cards constitute a predetermined suit. When there are cards corresponding to the deck of the predetermined ranks and the cards constitute a predetermined suit, the payout process of S5 is performed for a bet on the sub game.

The deck of predetermined ranks is same as in the first modified example. The suit is one of spade, club, heart and diamond.

In the payout process of S5, a table of FIG. 9 is referred to. To be more specific, regarding the playing cards put on the player card area 2a and the banker card area 2b, for example, when the deck of predetermined ranks is “7” and “8”, a predetermined suit is “diamond”, there are cards corresponding to the rank deck and all the cards are “diamonds”, the chips of an amount that is three times as much as the bet amount are paid out. In addition, when the deck of predetermined ranks is “A” and “7”, a predetermined suit is “heart”, there are cards corresponding to the rank deck and all the cards are “hearts”, the chips of an amount that is three times as much as the bet amount are paid out. In the mean time, when the deck of predetermined ranks is “J”, “Q” and “K”, a predetermined suit is “spade”, there are cards corresponding to the rank deck and all the cards are “spades”, the chips of an amount that is ten times as much as the bet amount are paid out. Like this, in this modified example, when the deck has the more different ranks, the payout rate is higher. For instance, in the example of FIG. 9, the deck having the three ranks of “J”, “Q” and “K” has the higher payout rate than the deck having the two ranks of “7” and “8” or “A” and “7.”

FIG. 10 shows an example of a game system that is used to execute the second modified example of a playing method of the present invention. The game system 1A of FIG. 10 is different from the game system of FIG. 1 in that the deck of predetermined different ranks, rather than one type of a rank, is displayed on the lucky number indicator 13 and a sheet indicator 14 is provided, and has the other elements same as the game system 1. In FIG. 10, a deck of ranks of “J”, “Q” and “K” is displayed on the lucky number indicator 13 and a “spade” is displayed on a suit indictor 14.

As described above, according to the first and second modified examples, it is possible to increase the sense of satisfaction of a game participant in a game, as the above embodiment. Furthermore, according to the first and second modified examples, in a sub game, a deck of ranks, rather than one type of a rank, is set, so that the results of various patterns are induced. Therefore, the taste of the game participant is further increased.

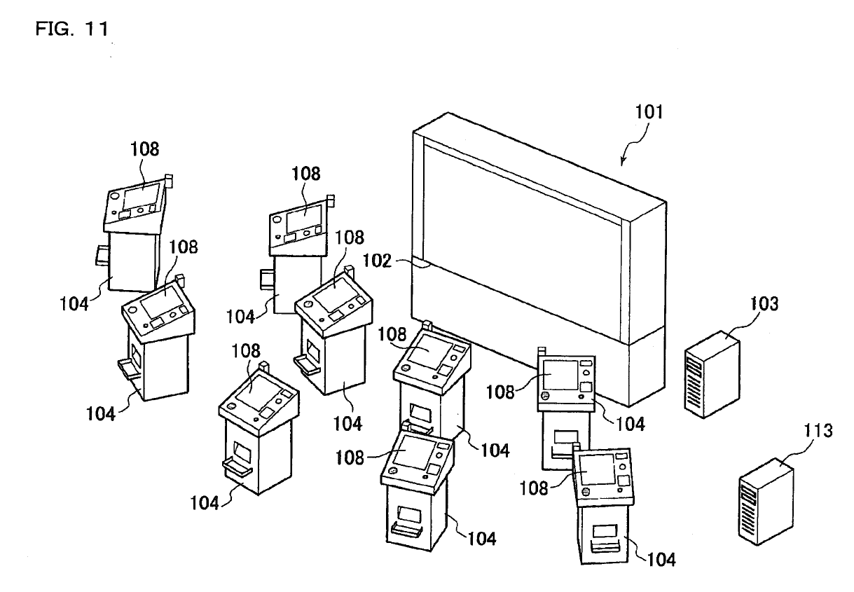

In the followings, an embodiment of a gaming device of the invention will be described with reference to FIGS. 11 to 24.

As shown in FIG. 11, a gaming device 101 of this embodiment includes a common display 102, a controller 103, nine terminals 104 and a server 113. Under control of the controller 103 and the server 113, an image showing contents of a baccarat game is displayed on the common display 102. Each of the terminals 102 is individually operated by a game participant (hereinafter, referred to as “user”), is disposed to be visible to the user of the terminal 104 and has a display 108. The terminals 104, the controller 103 and the server 113 are electrically associated with each other, through a short-distance communication network and the like. The common display 102 is electrically associated with the controller 103 through a dedicated communication cable and the like.

In this embodiment, maximum 9 users can take part in a game by operating the terminals 104, respectively.

As the embodiment of the playing method described with reference to FIGS. 1 to 7, a baccarat game including a main game and a sub game is executed in the gaming device 101. The rules of the main and sub games are same as in the above embodiment.

The baccarat game is repeatedly executed every predetermined period. The period for which the users of the respective terminals 104 can make a bet, i.e., a bet time is limited. When the bet time is over, a bet is prohibited until this game is over and a payout is completed. When the payout is completed, a next bet time is initiated and a bet on next main and sub games is allowed.

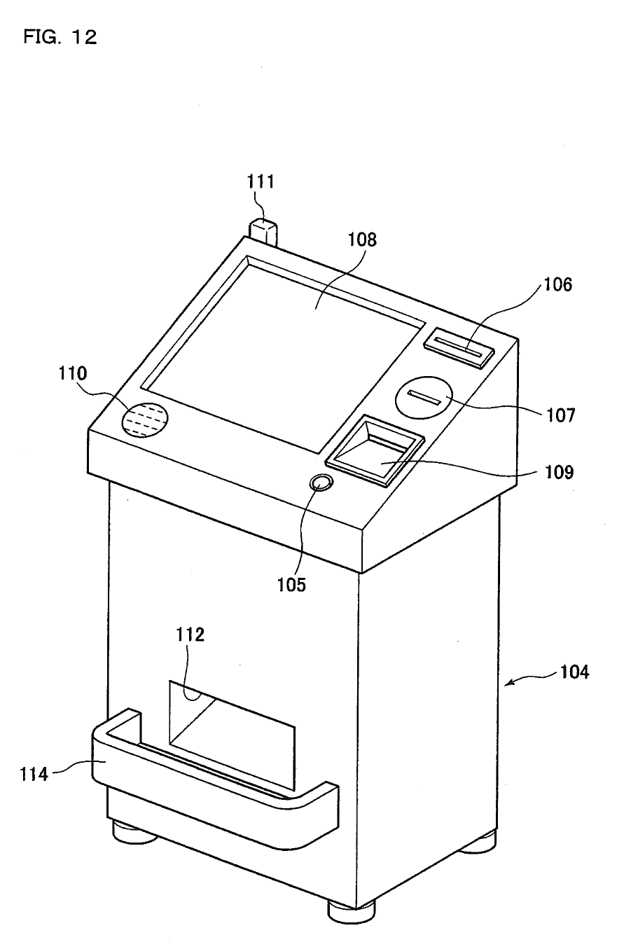

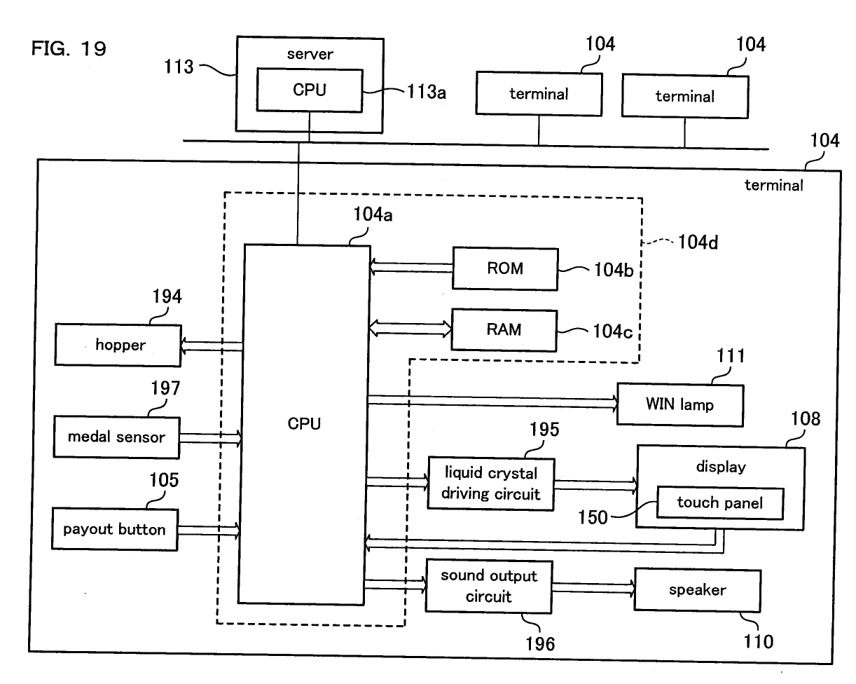

Here, a structure of the terminal 104 is described. As shown in FIG. 12, the terminal 104 has on its upper surface an insertion slot 107 into which a game medium having a currency value such as coin and medal is inserted, and a display 108 on which a game image is displayed. In this embodiment, a medal is used as a game medium. After inserting a medal into the insertion slot 107, a user of the terminal 104 touches the display 108 while seeing an image displayed on the display 108, making a bet a medal, which is credited as electronic information and possessed, through a touch panel 150 (see FIG. 19) provided to a front of the display 108.

A surface of the terminal 104 is further provided with a payout button 105, a ticket printer 106, a bill insertion slot 109 and a speaker 110. The front of the terminal 104 is provided with a medal discharge slot 112 and a medal tray 114.

The payout button 105 is a button for inputting an instruction to discharge the medals corresponding to the current credits from the medal discharge slot 112 when a game is over. The ticket printer 106 prints a barcode, in which the data such as credit-number, time and date, identification number of the terminal 104 and the like is coded, on a ticket and outputs the ticket as a ticket having a barcode printed thereon. The ticket having a barcode can be read out in another terminal 104 in which a bet can be then made, and can be exchanged with bill in a predetermined location of a game arcade, for example in a casher of a casino.

The bill insertion slot 109 identifies whether the bill is normal or not and receives the normal bill therein. The bill insertion slot 109 can read out a ticket having a barcode printed thereon. The speaker 110 outputs a music and an effect sound relating to a game, based on a signal from a sound output circuit 196 (see FIG. 19).

An upper part of the display 108 is provided with a WIN lamp 111. When a user of the terminal 104 wins a game, i.e., when the payout is performed for the user, the WIN lamp 111 is turned on. The WIN lamp 111 is provided at a position that is visible to the users of the other terminals 104. Thereby, all the users of the gaming device 101 can confirm a winner of a game by seeing the lighting-up of the WIN lamp 111.

A medal sensor 197 (see FIG. 19) that identifies whether the medal inserted into the insertion slot 107 is normal or not and counts the medals is provided in the insertion slot 107. A hopper 194 (see FIG. 19) that discharges the predetermined number of medals is provided in the medal discharge slot 112.

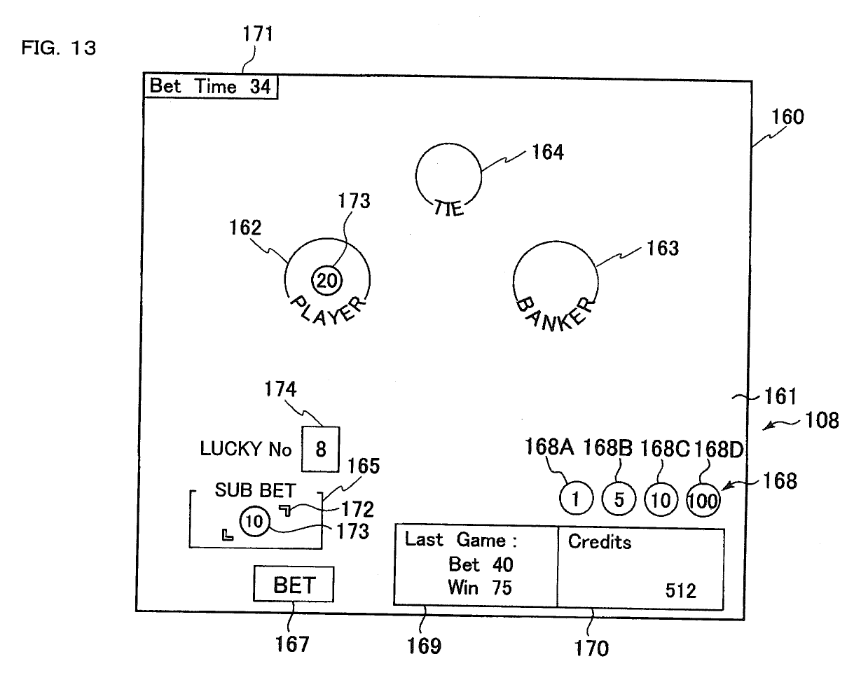

During a bet time, a BET screen 161 shown in FIG. 13 is displayed on the display 108. The BET screen 161 includes a table-type betting board 160.

The board 160 has player bet area 162, banker bet area 163, tie bet area 164 and sub bet area 165. The player bet area 162, the banker bet area 163 and the tie bet area 164 are areas for making a bet on a main game and the sub bet area 165 is an area for making a bet on a sub game.

A user makes a bet on a player bet area 162 when the user expects a win of “PLAYER”, on a banker bet area 163 when the user expects a win of “BANKER” and on a tie bet area 164 when the user expects a tie. The one user is prevented from making a bet on both the player bet area 162 and the banker bet area 163. The one user is allowed to make a bet on the player bet area 162 or banker bet area 163 and the tie bet area 164.

When a user wants to take part in a sub game, the user makes a bet on a sub bet area 165. When the user does not make a bet on the main game, i.e., when the user does not make a bet any of the player bet area 162, the banker bet area 163 and the tie bet area 164, the user cannot make a bet on the sub bet area 165.

A luck number indicator 174 is provided at the upper part of the sub bet area 165 in the board 160. The lucky number indicator 174 displays a lucky number relating to the sub game, as the lucky number indictor 13. In the example of FIG. 13, the lucky number is “8.” In the mean time, the lucky number indicator 174 may be provided to the common display 102, instead of the board 160.

The board 160 is provided on its lower part with a BET fix button 167, a unit BET button 168, a previous game result indicator 169 and a credit-number indicator 170.

The unit BET button 168 is contacted when designating a bet amount. The unit BET button 168 includes a 1 BET button 168A, a 5 BET button 168B, a 10 BET button 168C and a 100 BET button 168D.

The previous game result indicator 169 displays a bet amount and a payout amount of the previous game. An amount obtained by subtracting the bet amount from the payout amount corresponds to a credit-number that has been newly obtained by a user during the previous game.

The credit-number indicator 170 displays the credit-number that the user currently possesses. When a bet is made, the credit-number is decreased as the bet amount. When a payout is performed due to a win, the credit-number is increased as the payout amount. When the credit-number is 0, a user cannot take part in the game.

The board 160 has a BET time indicator 171 on its upper part. The BET time indicator 171 displays a remaining time period (seconds), for which a user can make a bet. When a bet reception is initiated, “60” is displayed and the number is decreased by 1 every one second. When “0” is displayed, the bet reception is ended. After the bet reception is ended, the display of the display 108 is fixed and a user is prohibited from making a bet.

The board 160 is further displayed with a cursor 172 that shows the bet areas 162 to 165 currently selected by the user, and a chip mark 173 that shows a bet amount currently indicated by the user. In FIG. 13, the credits of 20 are bet on “PLAYER” and the credits of 10 are bet on the sub game.

When making a bet using the BET screen 161, a user touches the bet areas 162 to 165 with a finger and the like to indicate a bet object with the cursor 172. Then, the user touches the unit BET button 168 to indicate a bet amount on the bet object. To be more specific, whenever the 1 BET button 168A is touched, the bet amount is increased by 1. Whenever the 5 BET button 168B is touched, the bet amount is increased by 5. Whenever the 10 BET button 168C is touched, the bet amount is increased by 10. Whenever the 100 BET button 168D is touched, the bet amount is increased by 100. For example, the 10 BET button 168C is touched four times, the 5 BET button 168D is touched one time and the 1 BET button 168A is touched three times, the bet amount is 48.

After the bet object and the bet amount are indicated by doing so, the user touches the BET fix button 167. Thereby, the bet object and the bet amount are fixed. The indicated bet object and bet amount can be changed when the BET fix button 167 is not touched.

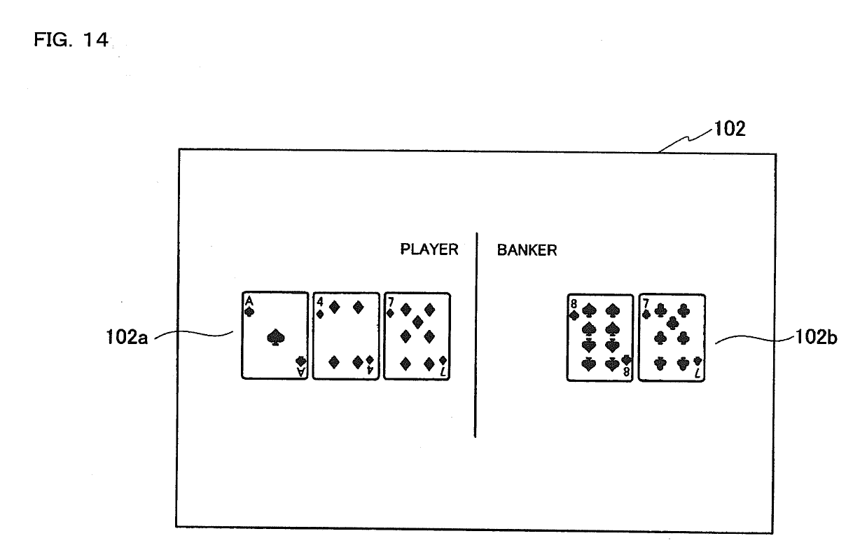

FIG. 14 is an example of an image that shows contents of a main game displayed on the common display 102. The common display 102 is provided with the player card area 102a and the banker card area 102b corresponding to the player card area 2a and the banker card area 2b of the game system 1 shown in FIG. 1 and the distributed playing cards are displayed on each of the card areas 102a, 102b.

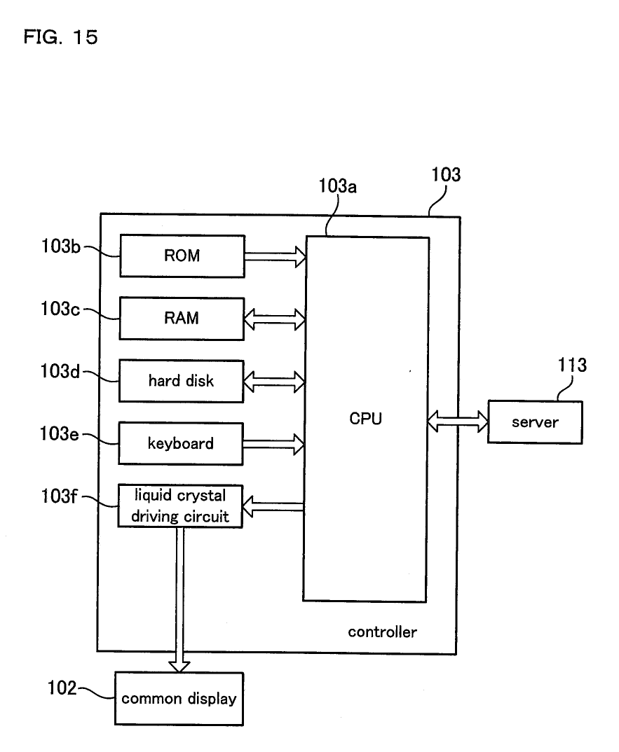

FIG. 15 is a block diagram that shows an electrical structure of the controller 103. As shown in FIG. 15, the controller 103 includes a ROM 103b, a RAM 103c, a hard disk 103d, a keyboard 103e and a liquid crystal driving circuit 103f, in addition to a CPU 103a that controls the whole controller 103. The liquid crystal driving circuit 103f is associated with the common display 102.

The hard disk 103d stores a game program so that an image showing the contents of a main game is displayed on the common display 102. The program is extracted from the hard disk 103d and stored in the RAM 103c in accordance with a command inputted through the keyboard 103e. Under control of the CPU 103a that is performed in accordance with a program stored in the ROM 103b, a game is executed. The CPU 103a performs a variety of processes based on a signal received from the server 113 and the data or programs stored in the ROM 103b and the RAM 103c, and transmits a signal to the common display 102 based on the process result. Thereby, the CPU 103a initiatively controls the display of the common display 102.

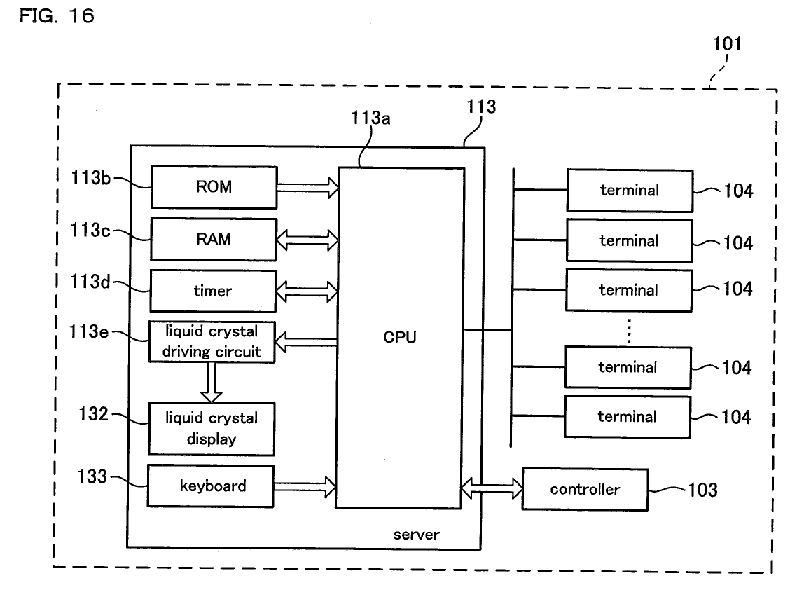

FIG. 16 is a block diagram that shows an electrical structure of the server 113. As shown in FIG. 16, the server 113 includes a ROM 113b, a RAM 113c, a timer 113d, a liquid crystal driving circuit 113e and a keyboard 133, in addition to a CPU 113a that controls the whole server 113. The liquid crystal driving circuit 113e is associated with the liquid crystal display 132.

The CPU 113a performs a variety of processes based on signals received from the respective terminals 104 and the data or programs stored in the ROM 113b and the RAM 113c, and transmits a signal to the terminals 104 based on the process result. Thereby, the CPU 113a initiatively controls the respective terminals 104. The CPU 113a also transmits a control signal related to the display of the common display 102 to the controller 103.

The ROM 113b is a semiconductor memory, for example and stores a program that realizes a basic function of the gaming device 101, a program that executes a notification of a maintenance time, a program that relates to a setting and a management of the notification condition, rules of the main and sub games, payout contents, i.e., credit-number to be granted, for a bet on the main and sub games, respectively, a program for initiatively controlling the respective terminals 104 and the like.

The RAM 113c temporarily stores the bet information including first and second bet information about the main and sub games, respectively, which are received from the respective terminals 104, the result data of a main game and a sub game, the result data of process executed by the CPU 113a and the like.

The timer 113d measures the time and transmits the time data to the CPU 113a. The CPU 113a controls a game based on the time data received from the timer 113d.

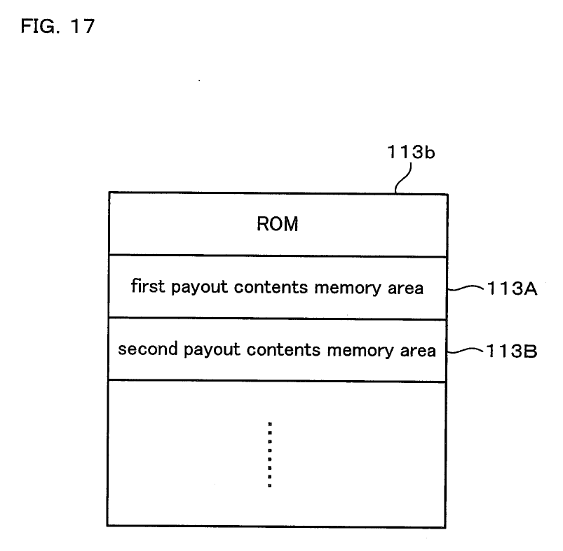

FIG. 17 schematically shows a memory area of the ROM 113b of the server 113. As shown in FIG. 17, the ROM 113b is provided with first and second payout contents memory areas 113A, 113B. The first payout contents memory area 113A stores the payout contents for a bet on a main game shown in FIG. 6. The second payout contents memory area 113B stores the payout contents for a bet on a sub game shown in FIG. 7.

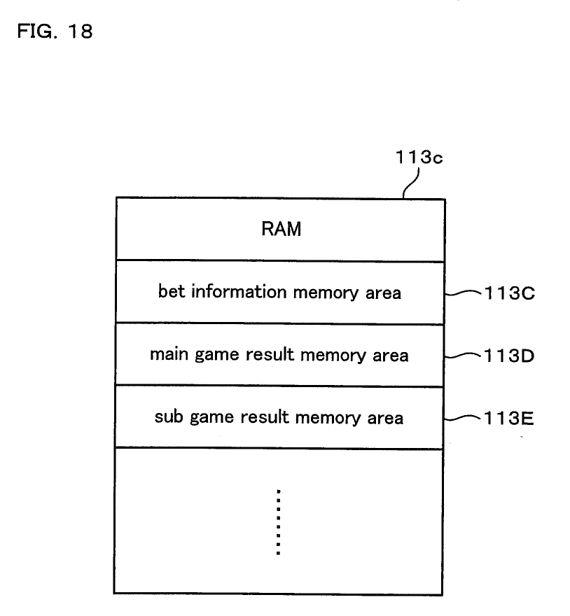

FIG. 18 schematically shows a memory area of the RAM 113c of the server 113. As shown in FIG. 18, the RAM 113c is provided with a bet information memory area 113C, a main game result memory area 113D and a sub game result memory area 113E. The bet information memory area 113C stores the current bet information. Here, the bet information includes the bet object and bet amount that are indicated by a user with the BET screen 161. The main game result memory area 113D and the sub game result memory area 113E store the results of the main game and sub game, respectively.

FIG. 19 is a block diagram showing an electrical structure of the terminal 104. The nine terminals 104 have the same structure. In the followings, only one terminal 104 will be described.

As shown in FIG. 15, the terminal includes a control unit 104d including a CPU 104a, a ROM 104b and a RAM 104c. The ROM 104b is a semiconductor memory, for example and stores a program that realizes a basic function of the terminal 104, various programs and data tables that are necessary for control of the terminal 104 and the like. The RAM 104c temporarily stores the various data that are calculated by the CPU 103a, the credit-number that is currently possessed by a user, the bet information indicated by a user and the like.

The CPU 104a is associated with each unit of the terminal 104, which will be described later. When a signal is received from each unit, the CPU 104a performs a variety of processes based on the signal and the data or programs stored in the ROM 104b and the RAM 104c, controls the respective units and transmits the process result data to the CPU 113a of the server 113.

When receiving a control signal from the CPU 113a of the server 113, the CPU 104a also controls each unit of the terminal 104 based on the control signal and makes the terminal 104 to progress a game. Alternatively, the CPU 104a performs a variety of processes based on the signals received from each unit of the terminal 104 and the data or programs stored in the ROM 104b and the RAM 104c, and progresses a game based on the process result.

The CPU 104a is associated with the payout button 105 (see FIG. 12) and the hopper 194. When a user presses the payout button 105, a signal is transmitted to the CPU 104a from the payout button 105. Based on the signal, the CPU 104a controls an operation of the hopper 194 so that the medals corresponding to the credit-number is discharged from the medal discharge slot 112.

The CPU 104a is associated with the display 108 through the liquid crystal driving circuit 195. The liquid crystal driving circuit 195 includes a program ROM, an image ROM, an image control CPU, a work RAM, a VDP (video display processor) and a video RAM. The program ROM stores an image control program relating to the display of the display 108, various selection tables and the like. The image ROM stores dot data for forming an image to be displayed on the display 108 and the like. The image control CPU determines an image to be displayed on the display 108 among the dot data stored in the image ROM, in accordance with the image control program stored in the program ROM, based on the parameters set by the CPU 104a. The work RAM is a temporary memory device that is used when the image control CPU executes an image control program. The VDP forms an image corresponding to the display contents determined by the image control CPU and outputs it on the display 108. The video RAM is a temporary memory device that is used when the VDP forms an image.

The information, which is inputted by a user through the touch panel 150, for example bet information is transmitted to the CPU 104a. The information is stored in the RAM 104c at any times. In addition, the information is transmitted to the CPU 113a of the server 113 and is stored in the bet information memory area of the RAM 113c.

The CPU 104a is associated with the sound output circuit 196 and the speaker 110. In addition, the CPU 104a is associated with the medal sensor 197. The medal sensor 197 counts the medals inserted into the insertion slot 107 (see FIG. 12) and transmits the insertion-number data to the CPU 104a. Based on the data, the PCU 104a increases the credit-number that is possessed by a user and is stored in the RAM 104c.

The CPU 104a is associated with the WIN lamp 111 (see FIG. 12). When a user of the terminal 104 wins a game, the CPU 104a turns on the WIN lamp 111.

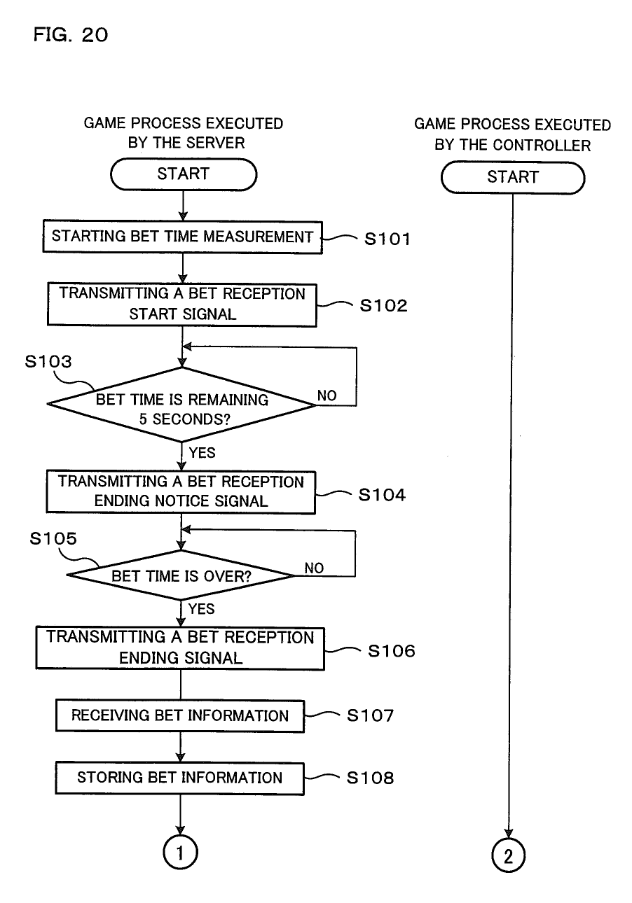

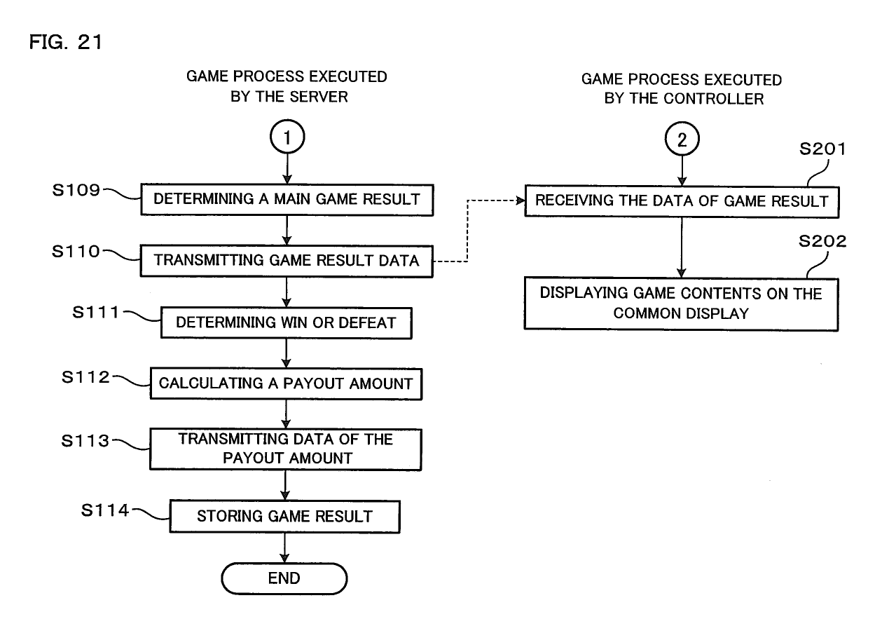

In the followings, a game process that the CPU 113a of the server 113 executes in accordance with the program stored in the ROM 113b and a game process that the CPU 103a of the controller 103 executes in accordance with the program stored in the ROM 103b will be described with reference to FIGS. 20 and 21.

First, the game process that the server 113 executes will be described.

As shown in FIG. 20, the CPU 113a starts a measurement of a bet time (S101). Then, the CPU 113a transmits a start signal, which shows that a bet reception is initiated, to the CPU 104a of each terminal 104 (S102).

After the step of S102, the CPU 113a determines whether the bet time is the remaining 5 seconds (S103). As described above, the remaining time (seconds) for which a user can make a bet is displayed on the BET time indicator 171 (see FIG. 13) of the display 108 of the terminal 104. When the CPU 113a determines that the bet time is not the remaining 5 seconds (S103, NO), it repeats the process of S103.

When the CPU 113a determines that the bet time is the remaining 5 seconds (S103, YES), it transmits a bet reception ending notice signal that notices a reception ending of a bet to the CPU 104a of each terminal 104 (S104). After the step of S104, the CPU 113a determines whether the bet time is over or not (S105). When the CPU 104a determines that the bet time is not over (S105, NO), it repeats the process of S105. When the CPU 104a determines that the bet time is over (S105, YES), the CPU transmits a bet reception ending signal, which indicates an ending of the bet reception, to the CPU 104a of each terminal 104 (S106).

After the step of S106, the CPU 113a receives the bet information from each terminal 104 (S107). Then, the CPU 113a stores the bet information in the bet information memory area 113C of the RAM 113c (S108).

After the step of S108, the CPU 113a determines results of a main game and a sub game, as shown in FIG. 21 (S109). When determining the result of the main game, the CPU 113a uses the random numbers sampled through a sampling circuit and the like and determines the types of the cards that are respectively distributed to “BANKER” and “PLAYER” and which one of “BANKER” and “PLAYER” will win a game or that “BANKER” and “PLAYER” will tie.

After the step of S109, the CPU 113a transmits to the CPU 103a of the controller 103 the data relating to the results determined in the step of S109 (S110).

After the step of S110, the CPU 113a determines the win or defeat in each terminal 104, based on the bet information received from each terminal 104 in the step of S107 and the results determined in the step of S109 (S111).

After the step of S111, the CPU 113a calculates the payout amount (S112). At this time, CPU 113a refers to the bet information of each terminal 104 and the payout contents of a bet on the main game and the sub game stored in the first and second payout contents memory areas 113A, 113B, and thus calculates the amounts of credits to be paid out to each terminal 104.

After the step of S112, the CPU 113a transmits to the CPU 104a of each terminal 104 the data relating to the payout amount calculated in the step of S112 (S113).

After the step of S113, the CPU 113a stores the results of the main game and the sub game determined in the step of S109 in the main game result memory area 113D and the sub game result memory area 113E, respectively (S114). After the step of S114, the CPU 113a ends this sub routine.

In the followings, the game process that the controller 103 executes will be described.

As shown in FIG. 21, the CPU 103a receives the data relating to the results of the main game and the sub game from the CPU 113a of the server 113 (S201). After the step of S201, the CPU 103a makes the common display 102 display the game contents, based on the data received in the step of S201 (S202). After the step of S202, the PCU 103a ends this sub routine.

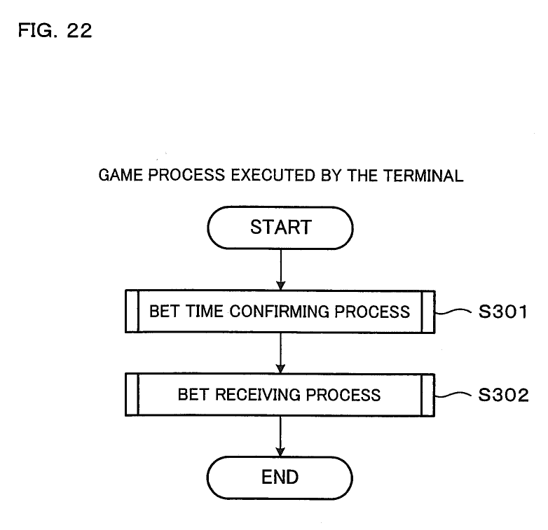

In the followings, a game process that the CPU 104a of the terminal 104 executes in accordance with the program stored in the ROM 104b will be described with reference to FIGS. 22, 23 and 24.

As shown in FIG. 22, the CPU 113a performs a bet time confirming process of S301 and then a bet receiving process of S302. Here, as a default, a flag “F” of the RAM 104c is set to be “1” indicating the bet time and the BET screen 161 (see FIG. 13) is displayed on the display 108.

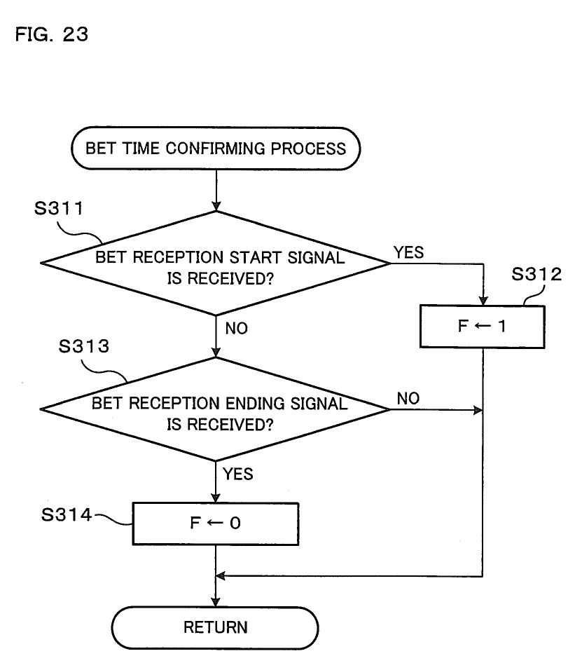

FIG. 23 is a flow chart showing the bet time confirming process of S301. The CPU 104a determines whether it receives a bet reception start signal from the CPU 113a of the server 113 (S311). When the CPU 104a determines that it receives a bet reception start signal (S311, YES), it set the flag “F” to be “1” (S312). Then, the CPU 104a ends the bet time confirming process.

When the CPU 104a determines that a bet reception start signal is not received (S311, NO), the CPU 104a determines whether it receives a bet reception ending signal from the CPU 113a of the server 113 (S313). When the CPU 104a determines that it receives a bet reception ending signal (S313, YES), it sets the flag “F” to be “0” (S314). Then, the CPU 104a ends the bet time confirming process.

When the CPU 104a determines that a bet reception ending signal is not received (S313, NO), it ends the bet time confirming process.

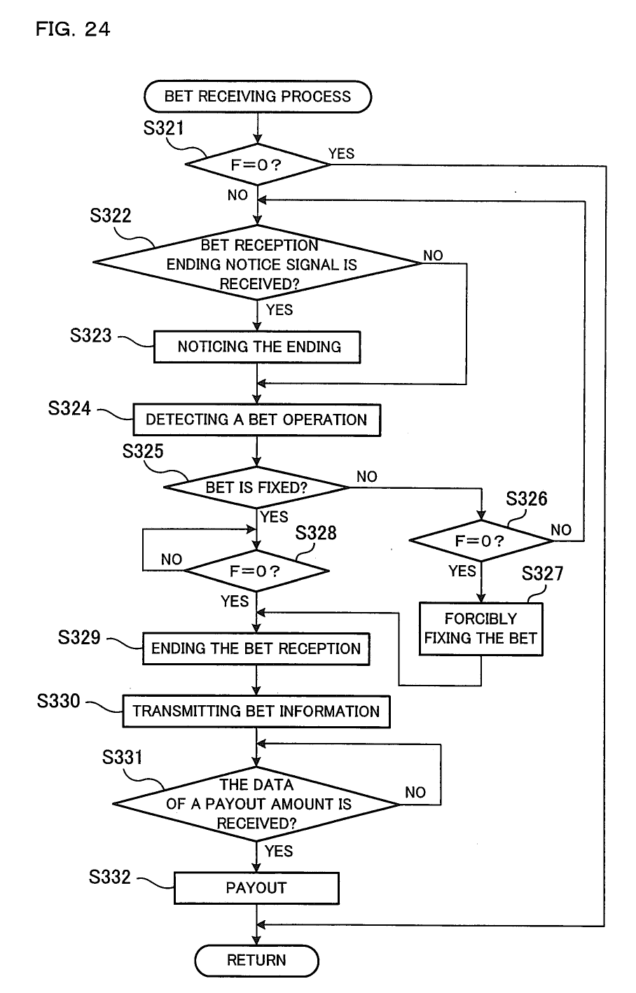

FIG. 24 is a flow chart showing the bet receiving process of S302. The CPU 104a determines whether the flag “F” is “0” or not (S321). When the CPU 104a determines that the flag “F” is “0” (S321, YES), it ends the bet receiving process.

When the CPU 104a determines that the flag “F” is not “0” (S321, NO), the CPU 104a determines whether it receives a bet reception ending notice signal from the CPU 113a of the server 113 (S322). When the CPU 104a determines that it receives a bet reception ending notice signal (S322, YES), it displays a message of noticing a bet reception end, such as “HURRY UP! THE BET TIME ENDING SOON.” On the BET screen 161 (see FIG. 13) displayed on the display 108 (S323).

After the step of S323 or when the CPU 104a determines that a bet reception ending notice signal is not received (S322, NO), it detects a bet operation of a user (S324). The bet operation means an operation of a user to touch the bet areas 162 to 165 or the unit BET button 168 while seeing the BET screen 161, as described above, and is detected by the touch panel 50. When a bet operation is detected, the chip mark 173 corresponding to the indicated bet amount is displayed on the indicated bet areas 162 to 165.

After the step of S324, the CPU 104a determines whether a bet is fixed, based on a signal from the BET fix button 167 (S325).

When the CPU 104a determines that a bet is not fixed (S325, NO), it determines whether the flag “F” is “0’ or not (S326). When the CPU 104a determines that the flag “F” is not “0” (S326, NO), it returns to the step of S322.

When the CPU 104a determines that the flag “F” is “0” (S326, YES), it forcibly fixes a bet, based on the bet operation detected in the step of S324 (S327).

When the CPU 104a determines that a bet is fixed (S325, YES), it determines whether the flag “F” is “0” or not (S328). When the CPU 104a determines that the flag “F” is not “0” (S328, NO), it repeats the step of S328.

After the step of S327, or when the CPU 104a determines that the flag “F” is “0” (S328, YES), it ends the bet reception (S329). After the step of S329, the CPU 104a transmits the bet information to the CPU 113a of the server 113 (S330).

After the step of S330, the CPU 104a determines whether it receives the data of a payout amount from the CPU 113a of the server 113 (S331). When the CPU 104a determines that the data of a payout amount is not received (S331, NO), it repeats the step of S331. When the CPU 104a determines that the data of a payout amount is received (S331, YES), it pays out the credit-number, based on the data (S332). To be more specific, the CPU 104a increases the credit-number stored in the RAM 104c by the payout amount. After the step of S332, the CPU 104a ends the bet receiving process.

In the mean time, the step of S114 in FIG. 21 may be performed at any time as long as it is performed after the step of S109.

The CPU 113a of the server 113, the CPU 104a of the terminal 104 and the CPU 103a of the controller 103 correspond to the controller of the present invention.

As described above, according to this embodiment, a user of the terminal 104 can make a bet on two events of a main game and a sub game during the one baccarat game. Thereby, it is possible to increase the sense of satisfaction of a user in a game.

In addition, in the sub game, the more the cards corresponding to the lucky number, the higher the payout rate, as the above embodiment. Thereby, the expectation to a payout is gradually increased with the display of the playing cards.

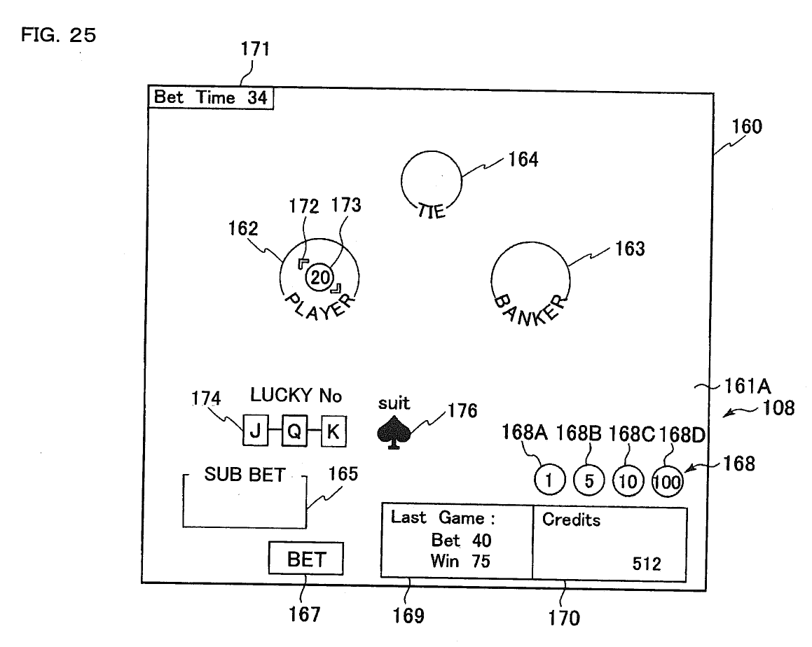

In the followings, a modified example of the embodiment of the gaming device of the invention will be described with reference to FIG. 25. This modified example is same as the above embodiment, except the BET screen displayed on the display 108 and the rules of the sub game.

The BET screen 161A of this modified example is different from the BET screen 161 of FIG. 13, in that the lucky number indicator 174 is displayed with a deck of predetermined different ranks, instead of the one type of a rank, and is provided with a sheet indicator 176, as shown in FIG. 25. The others are same as the BET screen 161. In FIG. 25, a deck of ranks of “J”, “Q” and “K” is displayed on the lucky number indicator 174 and a “spade” is displayed on the suit indicator 176.

In this modified example, the payout contents of a bet on the sub game shown in FIG. 9, not in FIG. 7 are stored in the second payout contents memory area 113B of the RAM 113c of the server 113.

As described above, according to the gaming device of this modified example, it is possible to increase the sense of satisfaction of a user in a game, as in the above embodiment. Furthermore, in this modified example, since a deck of ranks is set, rather than one type of a rank, in a sub game, the results of various patterns are induced, so that the user's taste is further increased.

In the mean time, the suit indicator 176 may be omitted from the BET screen 161A of this modified example and the payout contents of a bet on a sub game shown in FIG. 8 may be stored in the second payout contents memory area 113B of the RAM 113c of the server 113. Also in this case, it is possible to increase the sense of satisfaction of a user in a game. In addition, since a deck of ranks is set, rather than one type of a rank, in a sub game, the results of various patterns are induced, so that the user's taste is further increased.

In the present invention, a game, rather than the baccarat game, may be applied as a card game.

In the embodiments and the modified examples, the lucky number that is used in a sub game is determined before the bet reception is initiated. However, the invention is not limited thereto. For example, a game participant in the game system 1 or a user of the terminal 104 may arbitrarily indicate a rank or a deck of ranks. In addition, regarding the cards put on the player card area and the banker card area, it may be confirmed how many the cards corresponding to the indicated rank or deck of ranks are.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A playing method of a card game including a main game and a sub game that are performed when making a bet, the method comprising the steps of:
(a) making a first bet on the main game;
(b) making a second bet on the sub game;
(c) performing the main game after the first and second bets are made, and displaying a plurality of playing cards showing a result of the main game;
(d) performing a payout for the first bet in accordance with a rule of the main game, based on the result of the main game;
(e) counting how many the playing cards showing the result of the main game correspond to a predetermined rank; and
(f) performing a payout for the second bet in accordance with a rule of the sub game when there are a predetermined number of playing cards corresponding to the predetermined rank.

2. The playing method according to claim 1, wherein the rule of the sub game is such that the more the playing cards corresponding to the predetermined rank, the higher a payout rate.

3. A playing method of a card game including a main game and a sub game that are performed when making a bet, the method comprising the steps of:
(a) making a first bet on the main game;
(b) making a second bet on the sub game;
(c) performing the main game after the first and second bets are made, and displaying a plurality of playing cards showing a result of the main game;
(d) performing a payout for the first bet in accordance with a rule of the main game, based on the result of the main game;
(g) determining whether there are the playing cards, which show the result of the main game, corresponding to a deck of predetermined different ranks; and
(h) performing a payout for the second bet in accordance with a rule of the sub game when there are the playing cards corresponding to the deck of predetermined ranks.

4. The playing method according to claim 3, wherein the rule of the sub game is such that a payout rate is higher when the deck includes the more different ranks.

5. A playing method of a card game including a main game and a sub game that are performed when making a bet, the method comprising the steps of:
(a) making a first bet on the main game;
(b) making a second bet on the sub game;
(c) performing the main game after the first and second bets are made, and displaying a plurality of playing cards showing a result of the main game;
(d) performing a payout for the first bet in accordance with a rule of the main game, based on the result of the main game;
(i) determining whether there are the playing cards, which show the result of the main game, corresponding to a deck of predetermined different ranks and the playing cards constitute a predetermined suit; and
(j) performing a payout for the second bet in accordance with a rule of the sub game when there are the playing cards corresponding to the deck of predetermined ranks and the playing cards constitute a predetermined suit.

6. The playing method according to claim 5, wherein the rule of the sub game is such that a payout rate is higher when the deck includes the more different ranks.

7. The playing method according to claim 1, wherein the step of making a first bet is necessarily carried out.

8. The playing method according to claim 1, wherein the main game comprises a baccarat game.

9. A gaming device comprising:
a terminal that is operated by a user when making a bet based on a card game including a main game and a sub game;
a memory that stores a rule of the main game and a rule of the sub game; and
a controller that operates:
(a) to receive first bet information about the main game from the terminal;
(b) to receive second bet information about the sub game from the terminal;
(c) to perform the main game after receiving the first and second bet information, and to display a plurality of playing cards showing a result of the main game;
(d) to perform a payout for the first bet in accordance with the rule of the main game, based on the result of the main game;
(e) to count how many the playing cards showing the result of the main game correspond to a predetermined rank; and
(f) to perform a payout for the second bet in accordance with the rule of the sub game when there are a predetermined number of cards corresponding to the predetermined rank.

10. The gaming device according to claim 9, wherein the rule of the sub game is such that the more the playing cards corresponding to the predetermined rank, the higher a payout rate.

11. A gaming device comprising:
a terminal that is operated by a user when making a bet based on a card game including a main game and a sub game;
a memory that stores a rule of the main game and a rule of the sub game; and
a controller that operates:
(a) to receive first bet information about the main game from the terminal;
(b) to receive second bet information about the sub game from the terminal;
(c) to perform the main game after receiving the first and second bet information, and to display a plurality of playing cards showing a result of the main game;
(d) to perform a payout for the first bet in accordance with the rule of the main game, based on the result of the main game;
(g) determining whether there are the playing cards, which show the result of the main game, corresponding to a deck of predetermined different ranks; and
(h) performing a payout for the second bet in accordance with a rule of the sub game when there are the playing cards corresponding to the deck of predetermined ranks.

12. The gaming device according to claim 11, wherein the rule of the sub game is such that a payout rate is higher when the deck includes the more different ranks.

13. A gaming device comprising:
a terminal that is operated by a user when making a bet based on a card game including a main game and a sub game;
a memory that stores a rule of the main game and a rule of the sub game; and
a controller that operates:
(a) to receive first bet information about the main game from the terminal;
(b) to receive second bet information about the sub game from the terminal;
(c) to perform the main game after receiving the first and second bet information, and to display a plurality of playing cards showing a result of the main game;
(d) to perform a payout for the first bet in accordance with the rule of the main game, based on the result of the main game;
(i) determining whether there are the playing cards, which show the result of the main game, corresponding to a deck of predetermined different ranks and the playing cards constitute a predetermined suit; and
(j) performing a payout for the second bet in accordance with a rule of the sub game when there are the playing cards corresponding to the deck of predetermined ranks and the playing cards constitute a predetermined suit.

14. The gaming device according to claim 13, wherein the rule of the sub game is such that a payout rate is higher when the deck includes the more different ranks.

15. The gaming device according to claim 9, wherein the controller allows the reception of the second bet information after receiving the first bet information.

16. The gaming device according to claim 9, wherein the main game comprises a baccarat game.
